(19) United States
(12) Patent Application Publication
(10) Pub. No.: US 2022/0190338 A1
(43) Pub. Date: Jun. 16, 2022

(54) PROCESS FOR PREPARING AND USE OF HARD-CARBON CONTAINING MATERIALS

(71) Applicant: FARADION LIMITED, Sheffield, South Yorkshire (GB)

(72) Inventors: Jeremy BARKER, Sheffield, South Yorkshire (GB); Seyyed Shayan MEYSAMI, Sheffield, South Yorkshire (GB); Francesco MAZZALI, Sheffield, South Yorkshire (GB); Anthony RENNIE, Sheffield, South Yorkshire (GB)

(21) Appl. No.: 17/602,478

(22) PCT Filed: Apr. 1, 2020
(86) PCT No.: PCT/GB2020/050872

§ 371 Date: Oct. 8, 2021

(30) Foreign Application Priority Data
Apr. 9, 2019 (GB) 1905044.2

(51) Int. Cl. H01M 4/587; C01B 32/05; H01M 10/054

(52) U.S. Cl. CPC H01M 4/587; C01B 32/05; H01M 10/054; H01M 2004/021; C01P 2006/40; C01P 2002/72; C01P 2006/12

(57) ABSTRACT

The invention relates to a process for preparing hard carbon-containing material with a specific surface area of 100 m²/g or less, comprising the utilisation of one or more animal-derived materials.

### FIELD OF THE INVENTION

The present invention relates to the novel use of certain carbon-containing materials to produce hard-carbon-containing materials, to a novel process for making hard carbon-containing materials, to hard carbon-containing materials produced thereby, to electrodes which contain such hard carbon-containing materials and to the use of such electrodes in, for example, energy storage devices such as batteries (especially rechargeable batteries), electrochemical devices and electrochromic devices.

### BACKGROUND OF THE INVENTION

Sodium-ion batteries are analogous in many ways to the lithium-ion batteries that are in common use today; they are both reusable secondary batteries that comprise an anode (negative electrode), a cathode (positive electrode) and an electrolyte material, both are capable of storing energy, and they both charge and discharge via a similar reaction mechanism. When a sodium-ion (or lithium-ion) battery is charging, Na⁺ (or Li⁺) ions de-intercalate from the cathode and insert into the anode. Meanwhile charge balancing electrons pass from the cathode through the external circuit containing the charger and into the anode of the battery. During discharge the same process occurs but in the opposite direction.

Lithium-ion battery technology has enjoyed a lot of attention in recent years and provides the preferred portable battery for most electronic devices in use today; however, lithium is not a cheap metal to source and is considered too expensive for use in large scale applications. By contrast sodium-ion battery technology is still in its relative infancy but is seen as advantageous; sodium is much more abundant than lithium and some researchers predict this will provide a cheaper and more durable way to store energy into the future, particularly for large scale applications such as storing energy on the electrical grid. Nevertheless, a lot of work has yet to be done before sodium-ion batteries are a commercial reality.

One area that needs more attention is the development of new anode electrode materials, particularly for sodium-ion batteries.

Carbon, in the form of graphite, has been favoured for some time as an anode material in lithium-ion batteries due to its high gravimetric and volumetric capacity; graphite electrodes deliver reversible capacity of more than 360 mAh/g, comparable to the theoretical capacity of 372 mAh/g. The electrochemical reduction process involves Li+ions being inserted in between the graphene layers, to yield LiC₆. Unfortunately, however, graphite is much less electrochemically active towards sodium and this, coupled with the fact that sodium has a significantly larger atomic radius compared with lithium, results in the intercalation between graphene layers in graphite anodes being severely restricted in sodium-ion cells.

Anodes made using hard carbon materials, on the other hand, (such as described in US2002/0192553A1, U.S. Pat. No. 9,899,665B2, US2018/0287153A1) are found to fare much more favourably in sodium-ion cells. Hard carbons have disordered structures which overcome many of the insertion issues for sodium ions. The exact structure of hard carbon materials has still to be resolved, but in general terms hard carbon is described as a non-graphitisable carbon material lacking long-range crystalline order. Hard carbon has layers, but these are not neatly stacked in long range, and it is a microporous material. At the macroscopic level, hard carbon is isotropic. One of the reasons why it is difficult to construct a universal structural model of hard carbon is that detailed structures, domain size, fraction of carbon layers and micropores depend on the synthesis conditions, such as carbon sources and carbonisation temperatures. Usual methods for producing hard carbon materials which may be utilised in electrodes for secondary battery applications involve heating carbon-rich starting materials such as minerals, for example petroleum coke and pitch coke; secondary plant-based materials such as sucrose and glucose; man-made organic materials such as polymeric hydrocarbons and smaller organic compounds such as resorcinol formaldehyde; and primary plant-derived materials such as coconut shells, coffee beans, straw, bamboo, rice husks, banana skins, etc., to temperatures greater than 500° C. in an oxygen-free atmosphere. In the case when plant-derived materials are heated, “biochar” or biomass-charcoal is produced which may be further processed to obtain hard carbon material.

The aim of the present invention is to provide a new use of certain carbon-containing starting materials to produce hard carbon-containing materials. Further, the present invention aims to provide a new process for preparing hard carbon-containing materials which utilises the certain carbon-containing starting materials. The process will be cost effective, especially on a commercial scale, will use readily available materials and will produce hard carbon-containing materials that will at least match, and preferably surpass, known hard carbon-containing materials, in terms of their electrochemical performance and also in terms of their purity. The resulting hard carbon-containing materials will be useful as electrode active materials (particularly negative or anode electrode active materials) for use in energy storage devices such as batteries (especially secondary (rechargeable) batteries), alkali metal-ion cells (including sodium-ion cells), electrochemical devices and electrochromic devices. Importantly, these hard carbon-containing materials will produce energy storage devices that deliver an excellent first discharge specific capacity, and exhibit high first discharge capacity efficiency (coulombic efficiency), calculated as the ratio of the total charge extracted from the battery to the total charge put into the battery over a full cycle.

To accomplish these aims, the present invention uses carbon-containing starting materials which comprise animal-derived material. The term “animal-derived material”, as used herein, refers to material that can be derived from one or more animal sources. For example, the “animal-derived material” includes waste material (herein referred to as an “animal-derived waste material”) that remains after food has passed through, and has been excreted from, the digestive tract of an animal, i.e. the carbon-containing materials include animal faeces. Faeces from any animal source may be used, but the most abundant animal-derived waste material includes the faeces of chickens, sheep, horses, cattle, pigs and humans. Faeces derived from the latter is ideally in the form of sewage sludge or sewage sludge biochar. The animal-derived waste material may be derived from one or a mixture of animal sources, and further includes the faeces alone or in combination with other materials for example animal bedding materials, such as hay, straw, wood shavings; corn cobs and hulls; and mushroom compost. “Animal-derived material” also includes materials such as carcasses, bone, skin, hide, feathers, hair, horn and animal milk, all of which may be derived from any animal.

The animal-derived material provides a source of carbon which is converted using the process of the present invention into a hard carbon material that has a non-graphitisable non-crystalline structure, as described above.

Anodes which comprise the “hard carbon-containing material” produced in accordance with the present invention may either only contain the hard carbon materials which are made using one or more animal-derived materials as described above, or they may contain one or more of such hard carbon-containing materials in combination with one or more elements and/or compounds. Preferred example combinations include hard carbon (made according to the present invention)/X materials, where X may be one or more elements such as antimony, tin, phosphorus, sulfur, boron, aluminium, gallium, indium, germanium, lead, arsenic, bismuth, titanium, molybdenum, selenium, tellurium, silicon or carbon. Hard carbon/Sb, hard carbon/Sn, hard carbon/SbₓSn_{y}, hard carbon/silicon, hard carbon/siliconcarbide (HC/SiC), or hard carbon/sodium silicate are suitable hard carbon-containing materials. The one or more elements and/or compounds in combination with the hard carbon material may be derived during the manufacture of the hard carbon material, or alternatively the one or more elements and/or compounds may be added to the hard carbon-containing material after it has been made by the process of the present invention.

The present invention therefore provides a process for preparing a hard carbon-containing material which utilises at least one animal-derived material.

Animal-derived material, particularly animal-derived waste material, is typically transported in the form of dry or semi-dry pellets which, where necessary, can be milled, preferably to a particle size no larger than the size of the smallest particle of solid (non-carbon) impurity. Typically, the particle size of the animal-derived material is less than 5 mm and preferably less than or equal to 1 mm. Commercially obtainable animal-derived material may be in charred or uncharred form, for example in the case of human-derived waste material it is preferably in the form of sewage sludge (i.e. an aqueous suspension) for ease of transportation, and it is typically available in “charred” form.

Some animal-derived materials can be relatively pure, but more often they contain as much as 30% by weight of unwanted impurities (these will be non-carbon-based materials). Typically, these will be one or more selected from mineral-, metal ion- and non-metal-ion-containing impurities. Hereafter reference to “mineral-”, “metal-ion” and “non-metal-ion” shall be interpreted to include minerals, metals and non-metals in elemental and compound form).

It is important that as many of the unwanted impurities as possible are prevented from being carried through into the final hard carbon-containing material, or otherwise lead to the formation of other impurities in the final hard carbon-containing material, as this will adversely alter the columbic efficiency, the cycle life and/or absolute specific capacity performance of the final hard carbon-containing material when it is used as an active anode electrode material. Thus, a key aim of the present invention is to provide a final hard carbon-containing material, made using animal-derived materials, which contains no, or a very low, weight % of unwanted non-carbon-based impurities. In some circumstances, the final hard carbon-containing material produced by the process of the present invention may contain from 0 to 50% by weight of desirable non-carbon-based material (e.g. selected metal-ion- and non-metal-ion-containing materials which are derived from components found in the one or more animal-derived starting material composition). Preferably, the final hard carbon-containing material may contain 0 to 20% by weight and ideally 0 to 10% by weight of desirable non-carbon-based material.

In a preferred aspect, therefore, the present invention provides a process which employs steps to purify a composition comprising one or more animal-derived materials prior to the formation of the final hard carbon-containing material.

The animal-derived starting materials used in the process of the present invention are likely to contain unwanted inorganic impurities, for example certain unwanted mineral-containing impurities, such as rock-forming oxides and silicon-containing impurities (for example silica- and/or silicate-containing materials), derived, for example, from soil, sand and grit, in amounts which can be up to 20% by weight of the animal-derived starting materials. This is particularly the case for animal-derived waste material, which is obtained for example, as a result of the manures contacting the ground (soil/sand). Other sources of unwanted mineral-containing impurities (e.g silicon dioxide (SiO₂) may originate from the supplements commonly fed to the animal to reduce the release of ammonia from their bedding; this is particularly so in the case of poultry litter.

Unwanted mineral-containing impurities (particularly those which are of a higher density than the carbon-containing components and other metal- and/or non-metal-containing compounds present in the animal-derived material) may be conveniently removed by washing and filtration, centrifugation, and ‘heavy media separation’ or ‘sink and float separation’ techniques. The ‘heavy media separation’ or ‘sink and float separation’ technique includes dispersing a starting composition comprising one or more animal-derived materials in a volume of a liquid dispersant (e.g. water) that is at least twice, preferably up to eight (8) times, and ideally at least four (4) times, the volume of the starting material composition. A volume of water six (6) times the volume of the starting material composition is especially preferred. The dispersion (e.g. aqueous dispersion) of the starting material is ideally agitated (for example by stirring) to induce the sedimentation of solid unwanted mineral impurities that have a density higher than both the dispersant (e.g. water) and the organic (carbon-containing) matter present in the starting composition comprising the animal-derived material. The organic matter-rich supernatant (aqueous, when water is used as the dispersant) liqueur is then separated from the solid inorganic mineral-containing sediment, and the liquid (water, when used as the dispersant) is removed from the supernatant liqueur to yield a powdered animal-derived material that preferably contains less than 10% by weight of mineral impurities. This resulting material is termed herein as “high density (relative to the rest of the animal-derived starting material) mineral impurity-reduced animal-derived material”. Highly desirably, the powdered mineral impurity-reduced animal-derived material comprises 0% to <5% by weight of mineral-containing impurities, further preferably 0% to <2% by weight and highly preferably 0% to 0.5% by weight of mineral-containing impurities. The dispersant, exemplified here by water, is reusable and is preferably filtered and recycled back to the separation vessel.

In the case where the starting composition comprises one or more uncharred animal-derived material, it is preferably heated to effect “charring” (“carbonisation”), prior to any further purification steps, for example to remove metal-ion and non-metal-ion impurities. Ideally “charring” or “carbonisation” is performed using mineral impurity-reduced animal-derived material and involves heating the high-density mineral impurity-reduced animal-derived material at a temperature which is preferably below the crystallisation temperature of any remaining mineral-containing impurities. The terms “charring” and “carbonising” are used interchangeably herein, as are “charred” and “carbonised”. The charring step results in a charred animal-derived material that has an enriched carbon content and a reduced hydrogen, nitrogen and oxygen content, compared with the levels of hydrogen, nitrogen and oxygen present in the uncharred animal-derived material. A key purpose of carbonisation is to effectively lock the carbon into an insoluble matrix.

Preferably the charring process is performed at a temperature from 150° C. to ≤700° C., further preferably at a temperature from above 150° C. to ≤650° C. and especially preferably at a temperature from 200° C. to 600° C., and ideally at a temperature from above 150° C. to 550° C. Clearly, the temperature required needs to be such that causes carbonisation to occur, but excessive charring temperatures should be avoided a) to ensure that any amorphous impurities (for example any rock forming oxides or silicon-containing minerals which were not removed by filtration, centrifugation, sedimentation etc, as well as any other metal- and non-metal-containing materials) contained in the animal-derived material are not crystallised and become more difficult (and costly) to remove and b) to reduce unnecessary energy costs as a result of heating to high temperature.

Charring by heating the starting material may be performed for example in an electric or gas oven or other suitable heating apparatus or burning with a flame. A microwave oven may also be used as an additional or as an alternative means of charring. Charring is preferably performed over a period of time which ensures that all, or at least the majority (i.e. greater than 50% by weight) of the powdered reduced inorganic impurity-containing animal-derived material is charred or carbonised. Typically, this is indicated by the colour of the powdered reduced inorganic impurity-containing animal-derived material darkening in colour, preferably tending towards black. Preferably, the observed colour change is substantially uniform throughout the powdered mineral impurity-reduced animal-derived material. Further preferably the charring step is performed over a period of at least 30 minutes and ideally around 1 to 4 hours. It is advantageous if charring is performed in the absence of oxygen to prevent combustion, for example using an atmosphere containing one or a mixture of gases which may be selected from nitrogen, carbon dioxide, another non-oxidising gas and an inert gas such as argon. Alternatively, vacuum or partial vacuum could be used to minimise the oxygen abundance in the charring reactor. As discussed above, human-derived waste material is available in charred form, commonly referred to as ‘municipal waste biochar’ or ‘sewage sludge biochar’. The charring or carbonisation step may not be necessary if the composition comprises a charred animal-derived material.

The present invention, therefore, provides a process for preparing a hard carbon-containing material which comprises the steps:
a) providing a composition comprising one or more animal-derived materials which preferably contains less than 10% by weight of mineral-containing impurities;
b) where the composition in step a) comprises one or more uncharred animal-derived materials, heating the composition at a temperature of from 150° C. to 700° C. to char the one or more animal-derived materials to produce a charred animal-derived material;
c) treating the composition comprising charred animal-derived materials from either step a) or step b) to remove unwanted metal-ion- and/or non-metal-ion-containing impurities, and to yield a treated charred animal-derived material which contains less than 10% by weight of metal-ion- and/or non-metal-ion-containing impurities; and
d) pyrolysing the treated charred animal-derived material from step c) at a temperature of greater than 700° C. to 2500° C. to produce a hard carbon-containing material with a specific surface area of 100 m²/g or less.

A composition comprising one or more animal-derived materials which contains less than 10% by weight of mineral-containing impurities may be produced by subjecting one or more animal-derived starting materials to washing and filtration, centrifugation, ‘heavy media separation’ or ‘sink and float separation’ techniques as described above, to remove the unwanted mineral impurities, and particularly the minerals impurities with a density higher than that of the one or more animal-derived starting materials.

Treatment step c) preferably involves any suitable treatment process or the use of any suitable apparatus known to the skilled person, to separate and remove unwanted metal-, non-metal- and mineral-containing impurities from the carbon-containing materials contained in the charred animal derived materials. The non-metal- and metal-containing impurities may derive from mineral impurities which have not already been removed, for example using the filtration, centrifugation and sedimentation techniques described above, or may derive from other non-mineral sources found in the animal-derived starting material. Suitably, step c) may include the use of ion exchange materials, chromatographic separation techniques, electrophoresis separation techniques, the use of complexing agents or chemical precipitation techniques. The treated charred animal-derived material produced in step c) will preferably be at least 90% pure, i.e. it will contain no (0%) or low (<10 wt %) levels of metal-ion- (e.g. transition metal, alkali metal or alkaline earth metal), and non-metal-ion- (e.g. phosphorus, oxygen, hydrogen) containing impurities. Highly preferably, the amount of metal-ion- and non-metal-ion-containing impurities in the chemically treated charred material produced in step c) will be <5 wt %, further preferably <2 wt % and highly preferably 0 to 0.5 wt %. However, in some embodiments, it may be desirable to selectively retain one or more of the metal and/or non-metal elements, and/or metal-ion- and/or non-metal-ion-containing compounds in the animal derived material to act as a dopant in the final hard carbon material, thus the one or more elements and/or compounds in combination with the hard carbon material may be derived during the manufacture of the hard carbon material, as discussed above.

In the process of the present invention the treatment step c) will be performed on animal-derived material that has been charred, and further it will be performed before the pyrolysis step d).

In a very preferred embodiment, the process of the invention includes treatment step c) which involves chemical digestion in which the charred animal-derived material is chemically treated to dissolve any soluble metal-ion- and/or non-metal-ion-containing impurities, e.g.

elemental transition metal and/or transition metal-ion-containing compounds such as transition metal oxides, which are present in the charred animal-derived material. As demonstrated in the specific examples below, the performance of a chemical treatment before charring results in a large amount of animal-derived material being lost due to the digestion of organic components at extreme pH values, whilst chemical treatment performed after pyrolysis is expected to lead to residual moisture on the material, as well as surface functionalities and both of these would deteriorate the electrochemical performance of the resulting hard carbon-containing material.

This preferred chemical treatment step c) is performed in solutions with pH values of 8 or above and/or 6 or below, preferably 9 or above and/or 4 or below and consequently involves treating the charred animal-derived material using an alkaline solution and/or an acid solution.

The preferred temperature for a chemical treatment in step c) is at least 10° C. to less than 650° C., further preferably 50° C. to 550° C.

Depending upon the impurities present in the charred animal-derived material, a chemical treatment step c) may include an alkaline and/or an acid treatment. If both alkaline and acid treatments are used, it is recommended that an alkaline treatment is performed before the acid treatment.

Alkaline treatment is conducted in a concentrated solution of an alkaline reagent dissolved in a suitable solvent (preferably water). Preferably the solution will be at least a 2.0M (up to 28.0M) alkaline solution, or molten bath (preferably a pure molten bath). A highly preferred alkaline solution will have above 3.0M, preferably at least 3.0M and ideally around 4.0M concentration of the alkaline reagent. One or more alkaline reagents may be employed, for example one or more selected from an alkali metal, an alkaline earth metal, ammonia and an aqueous soluble hydroxide. Potassium hydroxide and sodium hydroxide, or a mixture of the two, are suitable alkaline reagents, and a molten bath comprising an alkali metal hydroxide, e.g. NaOH and/or KOH, is particularly ideal. Alkaline treatment is preferably performed over a period of at least 4 hours, and a 6-hour period is particularly preferred. Alkaline treatment may be conducted in air under normal atmospheric pressure, ideally at a temperature between around 450° C. to around 550° C., and most particularly up to a maximum of 500° C. One should avoid high alkali purification temperature as it will ‘activate’ the carbon by creating abundant open micropores leading to very high first-cycle loss values. These problems are demonstrated below in Comparative Example 3.

The resulting alkaline treated charred powdered animal-derived material is then removed from the alkali solution and washed at least once (preferably multiple times) with at least one solvent that dissolves and facilitates the removal of the unwanted metal and/or metal-ion-containing impurities as well as any residual alkaline reagent from the charred animal-derived material. Preferably the washing solvent is hot, preferably boiling, water. Deionised water is ideal. The resulting alkaline treated material from step c) is optionally dried, optionally using heating (preferably up to a maximum of 150° C., further preferably 50° C. to 120° C.) and further optionally under reduced pressure (preferably a dynamic vacuum), prior to it being either acid treated as described below, or pyrolysed in step d) also as described below.

Acid treatment, ideally performed in air and under atmospheric pressure conditions, in step c) involves treating the (alkaline treated, where performed) charred animal-derived material at a temperature of at least 60° C., and ideally at a temperature of between 80° C. and 120° C. in an acid solution which contains one or more acidic reagents. This acid treatment dissolves and thereby enables selective removal of further inorganics where unwanted, such as calcium, potassium, phosphorus and magnesium compounds as well as common transition metals and their oxides such as iron and manganese, which may be present in the (alkaline treated) charred animal-derived material. Suitable acids include one or more selected from hydrochloric acid, hydrofluoric acid, nitric acid and sulfuric acid. The acid solution is preferably dilute; 1.0M to less than 3.0M solutions work well, and a 2.0M solution, preferably a 2.0M HCl solution, is especially preferred. Acid treatment is preferably performed over a period of at least 4 hours, and a 6 hour is particularly preferred.

The resulting acid treated charred animal-derived material is then separated at the end of step c) and is preferably washed with at least one solvent to re-solubilise any ions which have formed during the acid treatment. Preferably the washing solvent is hot, further preferably boiling, water. Deionised water is again ideal. The resulting acid treated material from step c) is optionally dried, optionally using heating (preferably up to a maximum of 150° C., further preferably 50° C. to 120° C.) and further optionally under reduced pressure (preferably a dynamic vacuum), prior to it being pyrolysed in step d).

Pyrolysis step d) is required to remove oxygen-containing compounds from the surface of the chemically treated charred animal-derived material; it is known that such oxygen groups are liable to act as permanent anchor points for incoming charge carriers and contribute towards first cycle loss. Furthermore, it has been found that the specific surface area of the final hard carbon-containing material determines its level of irreversible capacity, and that this disadvantage is reduced in materials that have a low specific surface area (less than 100 m²/g); pyrolysis has the effect to reduce the specific surface area of the final hard carbon-containing material to less than 50 m²/g, preferably around 10 m²/g.

All specific surface area values given in the present application have been determined by BET N₂ analysis

Pyrolysis involves heating the alkaline and/or acid treated powdered charred animal-derived material obtained from step d) to a temperature of from greater than 700° C. to 2500° C., preferably from 800° C. to 2000° C., further preferably from 1000° C. to 1800° C. and ideally at a temperature of around 1200° C., over a period of 30 minutes to 8 hours (the ramp period). The high temperature conditions are then optionally maintained for a period of at least 10 minutes, preferably from 30 minutes to 2 hours (the dwell period). Oxygen is advantageously absent from the pyrolysis process and is preferably replaced with one or a mixture of gases selected from nitrogen, carbon dioxide, another non-oxidising gas and an inert gas such as argon. Ideal pyrolysis conditions include heating to around 1200° C. for 3 hours at a ramp rate of 2 ° C/min under 1 L/min flow of argon with an optional 1-hour dwell at 1000° C.

Following pyrolysis, the conditions are cooled/allowed to cool to enable handling of the resulting pyrolysed material. The resulting pyrolysed material is a hard carbon-containing material.

Prior to using the resulting hard carbon-containing material as an electrode active material it Is preferably milled to d₅₀ of ca. 8-25 pm and filtered through a 15-25 pm sieve to exclude larger particles.

The present invention further provides for the use hard carbon-containing material made using animal-derived material, as an electrode active material in secondary battery applications, especially in alkali metal-ion cells, including in sodium-ion cells.

The present invention still further provides an alkali metal-ion cell comprising at least one negative electrode (an anode), that comprises at least one hard carbon-containing materials derived from animal-derived material. The alkali metal-ion cell will also comprise a positive electrode (a cathode) which preferably comprises one or more positive electrode active materials selected from oxide-based materials, polyanionic materials, Prussian Blue Analogue-based materials, and cathode conversion-based materials (materials that store sodium primarily by a reconstitution or displacement mechanism involving significant bond breaking of the cathode host material; examples include but are not limited to CuSO₄, Cu₂P₂O₇, FeF₃, NaFeF₃ etc). Particularly preferably, the one or more positive electrode active materials comprise one or more selected from alkali metal-containing oxide-based materials and alkali metal-containing polyanionic materials, in which the alkali metal is one or more alkali metals selected from sodium and/or potassium, and optionally in conjunction with lithium. Certain positive electrode active materials contain lithium as a minor alkali metal constituent, i.e. the amount of lithium is less 50% by weight, preferably less than 10% by weight, and ideally less than 5% by weight, of the total alkali metal content,

The most preferred positive electrode active material is a compound of the general formula:

A_{1±δ}M¹ᵥM²_{w}M³ₓM⁴_{y}M⁵_{z}O_{2-c}

wherein

A is one or more alkali metals selected from sodium and/or potassium, and optionally with lithium;

M¹ comprises one or more redox active metals in oxidation state +2,

M² comprises a metal in oxidation state greater than 0 to less than or equal to +4;

M³ comprises a metal in oxidation state +2;

M⁴ comprises a metal in oxidation state greater than 0 to less than or equal to +4;

M⁵comprises a metal in oxidation state +3;

wherein

0≤δ≤1

V is >0;

W is ≥0;

X is ≥0;

Y is ≥0;

at least one of W and Y is >0

Z is ≥0;

C is in the range 0≤c<2

wherein V, W, X, Y, Z and C are chosen to maintain electrochemical neutrality.

For the avoidance of doubt, the term “one or more alkali metals selected from sodium and/or potassium, and optionally with lithium” is to be interpreted to include: Na, K, Na+K, Na+Li, K+Li and Na+K+Li.

Ideally, metal M² comprises one or more transition metals, and is preferably selected from manganese, titanium and zirconium; M³ is preferably one or more selected from magnesium, calcium, copper, tin, zinc and cobalt; M⁴ comprises one or more transition metals, preferably selected from manganese, titanium and zirconium; and M⁵ is preferably one or more selected from aluminium, iron, cobalt, tin, molybdenum, chromium, vanadium, scandium and yttrium. A cathode active material with any crystalline structure may be used, and preferably the structure will be O3 or P2 or a derivative thereof, but, specifically, it is also possible that the cathode material will comprise a mixture of phases, i.e. it will have a non-uniform structure composed of several different crystalline forms.

Highly preferred positive electrode active materials comprise sodium and/or potassium-containing transition metal-containing compounds, with sodium transition metal nickelate compounds being especially preferred. Particularly favourable examples include O3/P2-Na_{0.833}Ni_{0.317}Mn_{0.467}Mg_{0.1}Ti_{0.117}O₂, O3-Na_{0.95}Ni_{0.3167}Mn_{0.3167}Mg_{0.1583}Ti_{0.2083}O₂, P2-type Na_{2/3}Ni_{1/3}Mn_{1/2}Ti_{1/6}O₂, P2-Na_{2/3}(Fe_{1/2}Mn_{1/2})O₂, P′2-Na_{2/3}MnO₂, P₃ or P2-Na_{0.67}Mn_{0.67}Ni_{0.33}O₂, Na₃V₂(PO₄)₃, NaVPO₄F, KVPO₄F, Na₃V₂(PO₄)₂F₃, K₃V₂(PO₄)₂F₃, NaₓFe_{y}Mn_{y}(CN)₆.nH₂O (0≤5 x,y,z≤2; 0≤n≤10), KₓFe_{y}Mn_{y}(CN)₆.nH₂O (0≤x,y,z≤2; 0≤n≤10), O3, P2 and/or P3-KₓMn_{y}Ni_{z}O₂ (0≤x≤1 and 0≤y,z≤1).

Advantageously, the alkali metal-ion cells according to the present invention may use an electrolyte in any form, i.e. solid, liquid or gel composition may be used, and suitable examples include; liquid electrolytes such as x m NaPF6 (0≤x≤10) in either ethylene carbonate, EC: diethyl carbonate, DEC: propylene carbonate, PC=1:2:1 wt/wt or PC (with/without diluents such as HFE (1,1,2,2-Tetrafluoroethyl 2,2,3,3-tetrafluoropropyl ether) or D2 (1,1,2,2-Tetrafluoroethyl 2,2,2-trifluoroethyl ether)), with/without electrolytes additives such as 1,3-propanediolcyclic sulfate (PCS), P123 surfactant, Tris(trimethylsilyl) Phosphite (TMSP), Tris(trimethylsilyl) borate (TMSB), 1-Propene 1,3 Sultone, 1,3-Propanesultone; gel electrolytes based on either one of the following matrix materials used singularly or in conjunction with each other such as polyvinylidenefluoride (PVDF), hexafluoropropylene (HFP), poly(methylmethacrylate) (PMMA) or sodium carboxymethyl cellulose (CMC) and impregnated with a liquid electrolyte as mentioned above; or solid electrolytes such as NASICON-type such as Na₃Zr₂Si₂PO₁₂, sulphide-based such as Na₃PS₄ or Na₃SbS₄, hydride-based such as Na₂B₁₀H₁₀—Na₂B₁₂H₁₂ or β-alumina based such as Na₂O.(8-11)Al₂O₃ or the related β″-alumina based such as Na₂O.(5-7)Al₂O₃).

### BRIEF DESCRIPTION OF THE DRAWINGS

The present invention will now be described with reference to the following figures in which:

FIG. 1 shows a flow chart to illustrate a preferred process of the present invention;

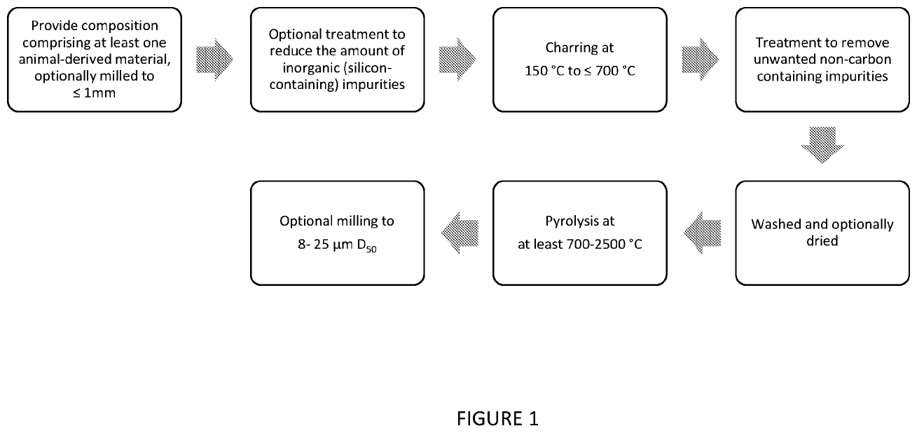

FIG. 2 shows an XRD pattern for the hard carbon-containing material derived from chicken manure using the process of the present invention described in Example 1;

FIG. 3 depicts sodiation/desodiation voltage (vs. sodium) profiles for the hard carbon material described in Example 1 which underwent a rate capability test from C/20 to 1C.

FIG. 4 depicts sodiation/desodiation voltage (vs. sodium) profiles for the hard carbon material described in Example 1 which underwent a rate capability test from C/50 to C/10.

FIG. 5 illustrates the cycle-life performance of an animal-derived hard-carbon-containing anode active material made according to Example 1 in a full sodium-ion cell formed between 1.0 and 4.2 V for two cycles followed by long-term cycling between 1.0 and 4.0 V at a charge and discharge rate of C/5 with a CV step of C/50.

FIG. 6 illustrates a voltage-capacity curve obtained from a three-electrode cell using anode material made according to Example 1.

FIG. 7 shows an XRD pattern for acid-washed sewage sludge prior to de-mineralisation in io Example 2; and

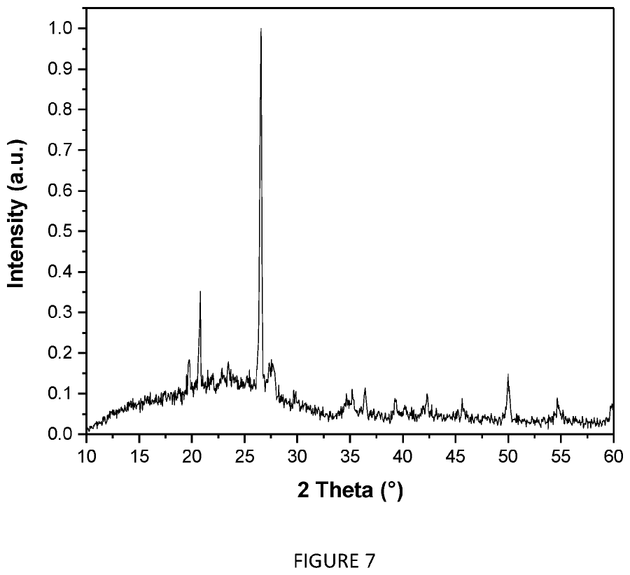

FIG. 8 shows an XRD pattern for carbon material extracted from de-mineralised sewage sludge before pyrolysis in Example 2.

FIG. 9A shows a sodiation/desodiation voltage (versus sodium) profile obtained for a comparative hard carbon material with a high specific surface area (in the range 500-1000 m²/g), prepared according to Comparative Example 3 (method as described in CN 107887602A).

FIG. 9B shows a sodiation/desodiation (versus sodium) profile for a hard carbon material prepared according to the process of the present invention.

FIG. 10A shows an electron micrograph of hard carbon-containing material prepared according to Comparative Example 3, reproduced from CN107887602A.

FIG. 10B shows an electron micrograph of hard carbon-containing material prepared according to the present invention which demonstrates that the material has no visible micropores.

### DETAILED DESCRIPTION

Hard carbon materials were made according to the pre process of the present invention as detailed below in Examples 1 and 2. Comparative Example 3 follows a method like that disclosed in prior art document CN107887602A.

### EXAMPLE 1

### Hard Carbon-Containing Material Prepared According to the Process of the Present Invention Using Chicken Manure-Derived Material

Obtained pelleted chicken manure is milled down to <1 mm and dispersed in water at a volume ratio of 1:6. The aqueous dispersion is agitated by stirring on a stirring plate and the inorganic impurities (e.g. primary silicates) were at least partially separated from the mixture by sedimentation due to the density of the rock-forming inorganic compounds commonly found in the chicken manure being higher than either the water or the biomass (heavy media separation). The biomass-rich supernatant is then extracted in a separate container by the means of reduced pressure to yield powdered chicken manure with reduced inorganic impurities.

The powdered reduced inorganic impurity chicken manure with is then rinsed with an organic solvent, e.g. acetone, and dried at 100° C. overnight. The organic solvent is used to accelerate the drying and reduce the foul smell, but is not essential. The inorganic impurity content of the dried powder is estimated by calcining a portion of (ca. 100 mg) of the dried powder at 1000° C. under atmospheric air and weighing the residual ash. The ash content of the dry powder is 9.9 wt. % which is significantly less than the 26.9 wt. % initial ash content of the as-received chicken manure. The powdered reduced inorganic impurity chicken manure is then charred at 600° C. for 4 hr under 1 L/min flow of argon, at a yield of ca. 40 wt. %. Higher charring temperatures are avoided to minimise the crystallisation of the remaining silica. The obtained charred (carbonised) chicken manure is then treated under reflux in boiling 4.0 M NaOH solution for 6 hr in air to minimise the impurity content. After rinsing the powder with boiling deionised water, chemical digestion is continued using boiling 2.0 M HCl solution for 6 hr to further minimise the content of calcium, potassium, phosphorus and magnesium compounds as well as common transition metals and their oxides such as iron and manganese. The resulting powder is rinsed again in boiling deionised water, dried and pyrolysed at 1200° C. for 3 hr at a ramp rate of 2° C./min under 1 L/min flow of argon with a 1-hour dwell at 1000° C., at a yield of ca. 77 wt. %. The powder is then milled to d₅₀ of ca. 10 μm and filtered through a 25 pm sieve to exclude larger particles.

Product Analysis using XRD

Analysis by X-ray diffraction techniques is conducted using a Siemens® D5000 powder diffractometer to confirm that the desired target materials had been prepared, to establish the phase purity of the product material and to determine the types of impurities present. From this information it is possible to determine the lattice parameters of the unit cells.

The general XRD operating conditions used to analyse the materials are as follows:

Slits sizes: 2 mm, 2 mm, 0.2 mm

Range: 2θ=10°-60°

X-ray Wavelength=1.5418 Å (Angstroms) (Cu Ka)

Speed: 1.0 seconds/step

Increment: 0.025°

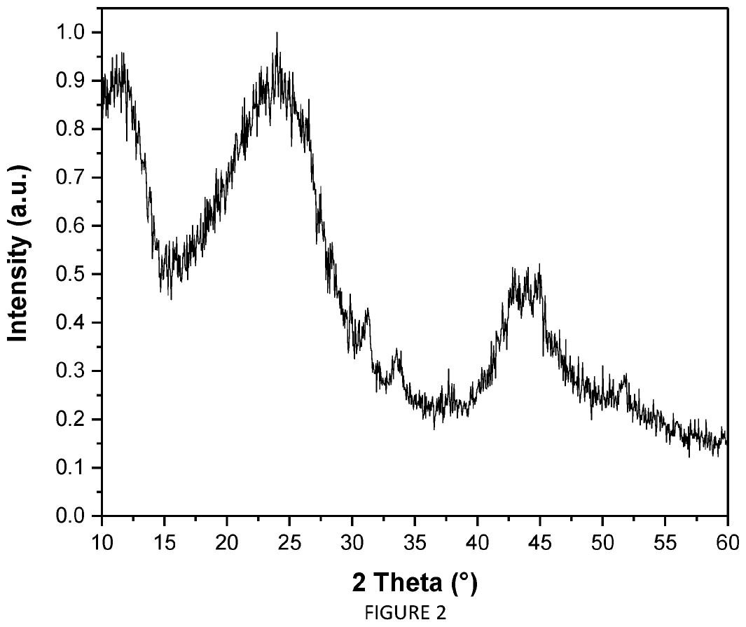

Table 1 below provides details of an estimation of the spacing of the graphitic crystallites as io well as their domain size (in-plane: La and stacking: Lc), using the information from the XRD pattern shown in FIG. 2.

TABLE 1

| | (002) 2-θ position | Spacing | XRD Lc | XRD La |
|---|---|---|---|---|
| Process | ° | nm | Nm | nm |
| 1200° C. (acid and | 23.93 | 0.371 | 2.134 | 6.716 |
| alkali digestions) | | | | |

### EXAMPLE 2

### Hard Carbon-Containing Material Prepared According to the Process of the Present Invention Using Human-Derived Waste Material (Sewage Sludge)

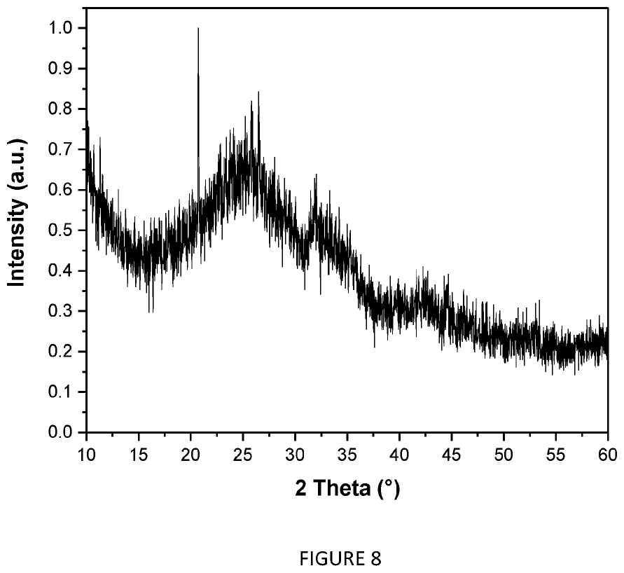

In a typical recycling process, wet sewage sludge is dewatered, dried and carbonised to obtain a biochar rich in phosphorous and minerals which can be directly used as phosphorous-rich fertilizer. To obtain a suitable biochar precursor for hard carbon synthesis, further treatment is required. De-mineralisation and de-phosphorisation of sewage sludge biochar is carried out in a molten alkali bath. During this process, dried sewage sludge biochar is mixed in equal weight proportion with NaOH powder in a glass container. The mixture is then heated at 500° C. for 3 hours in an oven under atmospheric air. The product collected after molten alkali digestion is rinsed multiple times with deionised water to remove the digested metal-containing impurities and all the residual NaOH. An x-ray diffraction pattern of the purified carbon obtained after the process of de-mineralisation is presented in FIG. 8. From this purified sewage sludge biochar, hard carbon is obtained through a pyrolysis process under inert atmosphere. Typically, the purified sewage sludge biochar is heated up to 1300° C. with a ramp rate of 2° C./min with an intermediate dwell time of 1 h at 1000° C. and is kept at 1300° C. for 3 hours, before being cooled down to room temperature for collection.

Electrochemical Results

Anodes comprising hard carbon-containing materials made according to Examples 1 and 2 are prepared by solvent-casting a slurry comprising the hard carbon material derived from pyrolysed animal-derived material (as described above), binder and solvent, in a weight ratio 92:6:2. A conductive carbon such as C65™ carbon (Timcal)® may be included in the slurry. PVdF is a suitable binder, and N-Methyl-2-pyrrolidone (NMP) may be employed as the solvent. The slurry is then cast onto a current collector foil (e.g. aluminium foil) and heated until most of the solvent evaporates and an electrode film is formed. The anode electrode is then dried further under dynamic vacuum at about 120° C.

Cell Testing

For half-cell tests, Hard Carbon electrodes are paired with one disk of sodium metal as reference and counter electrode. Glass Fibre GF/A is used as the separator and a suitable electrolyte is also used. Any suitable Na-ion electrolyte may be used, preferably this may comprise one or more salts, for example NaPF6, NaAsF6, NaClO4, NaBF4, NaSCN and Na triflate, in combination with one or more organic solvents, for example, EC, PC, DEC, DMC, EMC, glymes, esters, acetates etc. Further additives such as vinylene carbonate and fluoro ethylene carbonate may also be incorporated. A preferred electrolyte composition comprises 0.5 M NaPF6!EC:PC:DEC.

All cells were rested for 24 h prior to cycling. For three-electrode tests, Hard Carbon is used as negative electrode, a standard oxide material is used as positive electrode and a piece of sodium is used as reference, all three electrodes are wet by the same electrolyte. As separator, two polyethylene membranes of 24.5 urn thickness were used.

The half-cells are tested using Constant Current cycling technique, and the three electrode cells are tested using Constant Current—Constant Voltage technique.

The cell is cycled at a given current density between pre-set voltage limits. A commercial battery cycler from MTI Inc. (Richmond, Calif., USA) was used. On charge, alkali ions are inserted into the hard carbon-containing anode material. During discharge, alkali ions are extracted from the anode and re-inserted into the cathode active material.

The cell cycling results are shown as a function of anode specific capacity (rather than cathode specific capacity) as this is more informative for this application. The anode specific capacity is calculated by dividing the measured capacity by the mass of active component in the anode.

Results: Electrochemical Testing of the Hard Carbon Material According to Example 1

Specific capacity of the resulting hard carbon was obtained from half-cells. The results are io summarised in Table 2 below.

TABLE 2
Reversable sodiation/desodiation specific capacity
of hard carbon derived from chicken manure biochar
at different rates vs. sodium metal.

Reversible sodiation/desodiation
specific capacity vs. sodium [mAh/g]

| Rate | Cell 1 | Cell 2 | Cell 3 | Cell 4 |
|---|---|---|---|---|
| C/50 | — | — | 300/291 | 287/279 |
| C/20 | 236/224 | 254/241 | — | — |
| C/10 | 172/169 | 180/174 | 180/174 | 197/190 |
| C/5 | 116/114 | 130/126 | — | — |
| C/2 | 74/72 | 79/76 | — | — |
| 1 C | 39/38 | 42/41 | — | — |

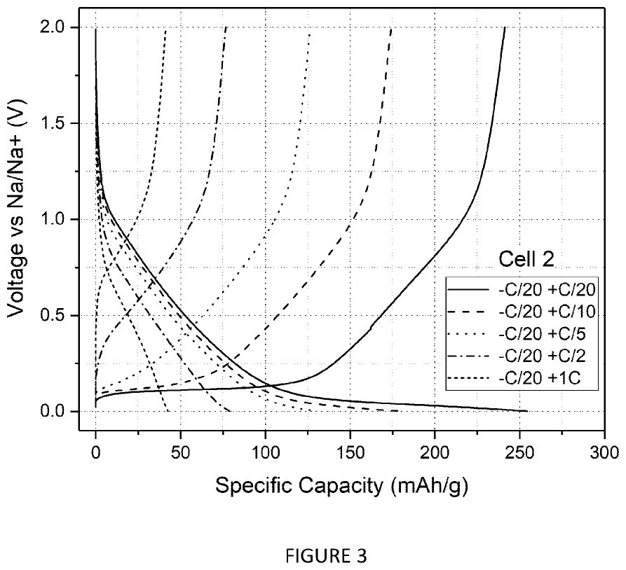

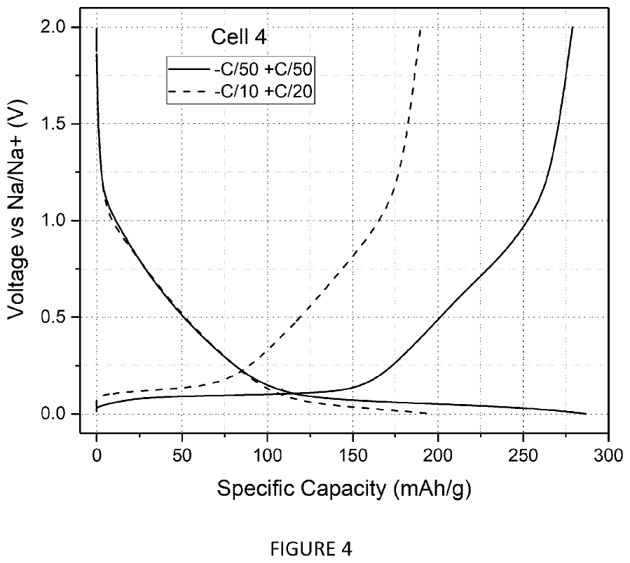

FIG. 3 and FIG. 4 depict representative sodiation/desodiation voltage (vs. sodium) profiles, numerical values are also reported in Table 2. The equivalent current rate used at 1C is 190 mA/g. Cell 2 (FIG. 3) is representative of the rate capability between C/20 and 1C (sodiation at C/20, desodiation at increasing current rate). Cell 4 (FIG. 4) is representative of the rate capability between C/50 and C/10 (sodiation/desodiation at C/50 followed by sodiation at C/10 and desodiation at C/20). From the voltage profiles, especially at low current rate, two section can be identified. The first section being a sloping region, attributed to alkali ions storage within layers and/or defects, and the second section being a plateau region, attributed to alkali ions storage within pores and voids. The voltage profiles and rate capabilities of animal-derived Hard Carbon (in particular, from chicken-manure biochar) prove to be in line with previously reported Hard Carbon materials.

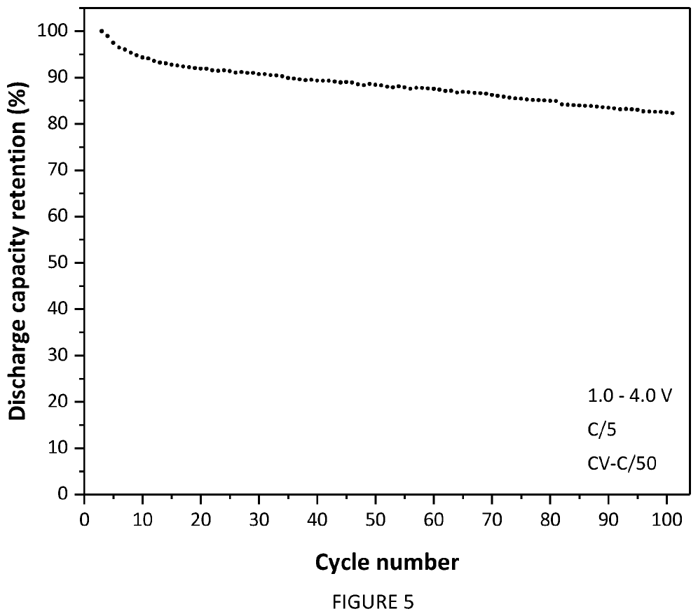

FIG. 5 illustrates the cycle-life performance of a representative animal-derived hard-carbon-containing anode active material in a full sodium-ion cell formed between 1.0 and 4.2 V for two cycles at Constant Current of C/10 with Constant Voltage step until C/100, followed by long-term cycling between 1.0 and 4.0 V at a charge and discharge rate of C/5 with a Constant Voltage step until C/50. 79% of the discharge capacity was retained after 130 cycles at current rate of C/5, proving that good reversible alkali ion storage can be attained within the animal-derived hard-carbon.

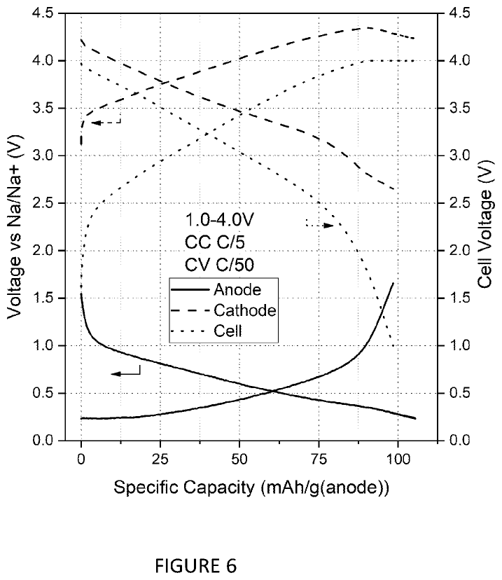

FIG. 6 illustrates representative voltage-capacity curves obtained from a three-electrode cell. The capacity is provided based on active mass of hard carbon. The sodium-ion full cell performances prove the suitability of animal-derived waste biochar material as a precursor for synthesis of hard carbon anode material.

### EXAMPLE 3

### Comparative Hard Carbon Material with a High Specific Surface Area (Above 580 m²/g)

A biaochar sample was mixed with sodium hydroxide and heated up to 650° C. This was followed by a neutralisation step which resulted in a hard carbon-containing material with a high specific surface area of 500-1000 m²/g.

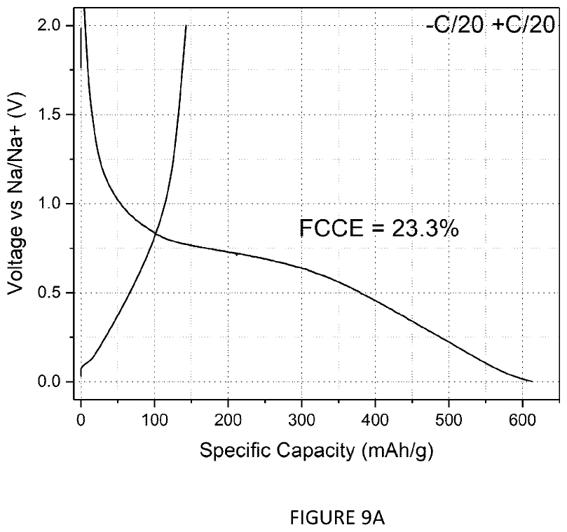

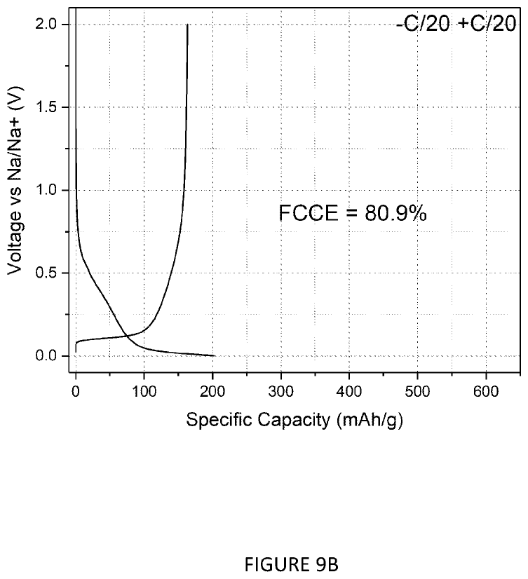

As shown in FIG. 9A, the resulting hard carbon material exhibits sodiation and desodiation behaviour of this material with a large irreversible capacity; the first cycle coulombic efficiency is only 23.3%.

By contrast, the first cycle coulombic efficiency for hard carbon material produced according to the present invention (i.e. with a much lower surface area), as shown in FIG. 9B, is 80.9%. FCCE is of particular importance in the case of secondary batteries with fixed inventory of charge carriers.

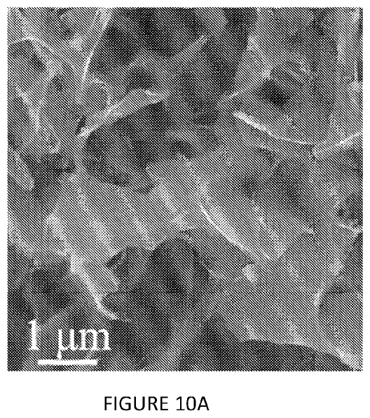

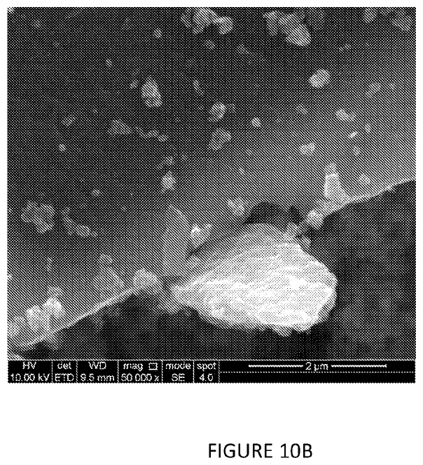

It is believed that the poor first cycle coulombic efficiency results are due to the produced material having an excessively high surface area (500-1000 m²/g) resulting from the high temperature used in the alkali treatment step and ii) the lack of a secondary high-temperature (>700° C.) heat treatment (referred to as ‘pyrolysis’ in the process of the present invention) which results in oxygen and nitrogen groups from the alkaline/acid digestion being retained on the surface of the hard carbon-containing material. Electron micrographs of the hard carbon-containing materials made according to Comparative Example 3 and according to the present invention are shown in FIGS. 10A and 10B, respectively. As can be seen, the FIG. 10A illustrates a highly porous hard carbon-containing material, whereas FIG. 10B illustrates an essentially non-porous hard carbon-containing material.

### EXAMPLE 4

### Experiments to Demonstrate the Need for the Charring, Chemical Treatment and Pyrolysis Steps in the Process of the Present Invention

A key advantage provided by the process of the present invention is to maximise the amount and/or quality (including purity) of the hard carbon material which can be produced from animal-derived material. The way this is achieved is by using an initial charred material which is treated to selectively remove various impurities before it undergoes pyrolysis—i.e. all three steps; charring, treating to remove impurities and pyrolysis, are required, and they also need to be performed in this specific order. This is demonstrated by the iterations detailed in Table 3 below:

TABLE 3

| | | Ash | Pyrolysis | |
|---|---|---|---|---|
| | | content | yield | |
| Processing steps | | (wt. %) | (wt. %) | Comments |
| 1 | Ground → Dried | >27 | <10 | Low pyrol- |
| | | | | ysis yield |
| | | | | Low purity |
| 2 | Ground → Separated from | >10 | <10 | Low pyrol- |
| | sand → Dried | | | ysis yield |
| | | | | Low purity |
| 3 | Ground → Separated from | <2 | >60 | High pyrol- |
| | sand → Carbonised at 500° | | | ysis yield |
| | C. → Leached in pure boiling | | | High purity |
| | NaOH → Digested in boiling | | | |
| | acid solution → Rinsed → | | | |
| | Dried | | | |
| 4 | Ground → Separated from | <2 | <5 | Low charring |
| | sand → Digested in cold | | | yield |
| | acid solution → Rinsed → | | | High purity |
| | Dried | | | |
| 5 | Ground → Separated from | <1 | <5 | Very low |
| | sand → Leached in boiling | | | charring yield |
| | NaOH solution → Digested in | | | High purity |
| | boiling acid solution → | | | |
| | Rinsed → Dried | | | |

As Table 3 shows, chemical treatment steps (acid-digestion, leaching in NaOH, etc.) will be effective to purify (remove inorganic/metal/non-metal impurities) an animal-derived starting material, however, carrying out such chemical treatment steps on non-carbonised (uncharred) animal-derived material will significantly solubilise the organic components of the animal-derived starting material and will result in a poor post-pyrolysis yield. Additionally, it is favourable to perform the chemical treatment steps before pyrolysis to remove the oxygen groups from the surface of the final hard carbon-containing material (as discussed above). Further, an initial carbonisation is essential to lock the carbon atoms in a carbonous matrix (rather than the initial inorganic compounds) so that the carbon content is preserved in following chemical treatments. Iteration 3 is found to provide the highest pyrolysis yield as well as an acceptable purity level.

1. A process for preparing a hard carbon-containing material comprising the utilisation of one or more animal faeces-derived materials.

2. The process for preparing a hard carbon-containing material according to claim 1, comprising the steps:
a) providing a composition comprising one or more animal faeces-derived materials;
b) where the composition in step a) comprises one or more uncharred animal faeces-derived materials, heating the composition at a temperature of from 150° C. to 700° C. to char the one or more animal faeces-derived materials to produce a charred animal faeces-derived materials;
c) treating the composition comprising charred animal faeces-derived materials from either step a) or step b) to remove any unwanted metal-ion- and/or non-metal-ion-containing impurities; and
d) pyrolysing the treated charred animal faeces-derived materials from step c) at a temperature of greater than 700° C. to 2500° C.

3. The process according to claim 2 wherein the composition comprising one or more animal faeces-derived materials provided in step a) comprises less than 10% by weight of mineral-containing impurities.

4. The process according to claim 2 where treatment step c) comprises a chemical digestion using alkaline and/or acid conditions.

5. The process according to claim 1, wherein the hard carbon-containing material exhibits a BET (N₂) specific surface area of 100 m²/g or less.

6. The process according to claim 6, wherein the hard carbon-containing material has a carbon-content of at least 90% by weight.

7. The process according to claim 6, wherein the hard carbon-containing material comprises up to 50% by weight of metal-ion- and/or non-metal-ion-containing components.

8. The process according to claim 1, wherein the one or more animal faeces-derived materials comprise human faeces-derived materials.

9. (canceled)

10. A hard carbon-containing material made by the process according to claim 1.

11. A hard carbon-containing material made by the process according to claim 2.

12. An electrode comprising the hard carbon-containing material according to claim 11.

13. An energy storage device comprising one or more electrodes according to claim 12.

14. A hard carbon-containing material derived from one or more animal faeces-derived materials having a BET (N₂) specific surface area of 100 m²/g or less.

15. An electrode comprising the hard carbon-containing material according to claim 14.

16. An energy storage device comprising one or more electrodes according to claim 15.
